(19) United States
(12) Patent Application Publication
(10) Pub. No.: US 2019/0187522 A1
(43) Pub. Date: Jun. 20, 2019

(54) LIQUID CRYSTAL DISPLAY DEVICE

(71) Applicant: SHARP KABUSHIKI KAISHA, Osaka (JP)

(72) Inventors: TAKASHI KATAYAMA, Sakai City (JP); SHINPEI HIGASHIDA, Sakai City (JP); TAKAHIRO SASAKI, Sakai City (JP); KAZUTAKA HANAOKA, Sakai City (JP); KIMIAKI NAKAMURA, Sakai City (JP); HIDEFUMI YOSHIDA, Sakai City (JP); SHINJI SHIMADA, Sakai City (JP)

(21) Appl. No.: 16/224,437

(22) Filed: Dec. 18, 2018

(30) Foreign Application Priority Data
Dec. 20, 2017 (JP) 2017-244491

(51) Int. Cl. G02F 1/1343; G02F 1/137

(52) U.S. Cl. CPC G02F 1/134363; G02F 2001/133738; G02F 1/137

(57) ABSTRACT

The liquid crystal display device including: a first substrate; a liquid crystal layer; and a second substrate, the first substrate including a first electrode, and a second electrode, the liquid crystal molecules being aligned in a direction parallel to the first substrate with no voltage applied, the second electrode being provided with openings, the openings each having a long shape with two or more wide portions and one or more narrow portions, the two or more wide portions and the one or more narrow portions in each of the openings alternating with each other in a lengthwise direction of the opening, each of the wide portions of one of adjacent two openings being adjacent to one of the narrow portions of the other of the adjacent two openings, each of the narrow portions of the one opening being adjacent to one of the wide portions of the other opening.

### CROSS-REFERENCE TO RELATED APPLICATIONS

The present application claims priority under 35 U.S.C. § 119 to Japanese Patent Application No. 2017-244491 filed on Dec. 20, 2017, the contents of which are incorporated herein by reference in their entirety.

### BACKGROUND OF THE INVENTION

### Field of the Invention

The present invention relates to liquid crystal display devices. More specifically, the present invention relates to a horizontal alignment mode liquid crystal display device.

### Description of Related Art

Liquid crystal display devices are display devices that utilize a liquid crystal composition for display. A typical display mode thereof is one applying voltage to a liquid crystal composition sealed between a pair of substrates to change the alignment state of liquid crystal molecules in the liquid crystal composition according to the applied voltage, thereby controlling the amount of light transmitted. These liquid crystal display devices, having characteristics such as thin profile, light weight, and low power consumption, have been used in a broad range of fields.

The display modes of liquid crystal display devices include horizontal alignment modes, which control the alignment of liquid crystal molecules by rotating the liquid crystal molecules mainly in the plane parallel to the substrate surfaces. The horizontal alignment modes have received attention because, with these modes, properties such as wide viewing angle characteristics can be easily achieved. For example, the in-plane switching (IPS) mode and the fringe field switching (FFS) mode, both are horizontal alignment modes, are widely used in recent liquid crystal display devices for smartphones or tablet terminals.

There is continuing research and development of the horizontal alignment modes to achieve a high transmittance and a high response speed, for example, to improve the display quality. JP 2014-232136 A, for example, discloses a display device as a technique to increase the response speed. The display device comprises a liquid crystal layer disposed between the first substrate and the second substrate facing each other. The first substrate has a first electrode and a second electrode. The first electrode or the second electrode includes an electrode base extending in a first direction, and a plurality of comb tooth portions, which extend in a second direction different from the first direction and protrude in a comb-tooth shape from the electrode base at a constant interval. In the initial alignment of liquid crystals in the liquid crystal layer, the major axes of the liquid crystal molecules are aligned in a third direction parallel to the second direction, and the angle formed by an electrode base-side portion of a long side of each of the comb tooth portions and the third direction is larger than an angle formed by an end-side portion of the long side of each of the comb tooth portions and the third direction.

The horizontal alignment modes offer the advantage of wide viewing angles, but have the problem of slow response as compared with vertical alignment modes such as the multi-domain vertical alignment (MVA) mode. JP 2014-232136 A discloses in FIG. 19, for example, a structure in which the ends of a comb tooth portion extending from one of adjacent electrode bases and the ends of a comb tooth portion extending from the other of the electrode bases are alternately arranged. JP 2014-232136 A also discloses in FIG. 20, for example, a structure in which the ends of a comb tooth portion extending from one of adjacent electrode bases and the ends of a comb tooth portion extending from the other of the electrode bases are arranged to face each other. In the liquid crystal display device disclosed in JP 2014-232136 A having such an electrode structure, application of voltage between the electrodes is likely to cause liquid crystal molecules in a region near the right long side of the comb tooth portion and in a region near the left long side of the comb tooth portion to be affected by opposite electric fields to rotate the liquid crystal molecules in opposite directions. Thus, the response speed can be increased in the horizontal alignment mode as well. However, liquid crystal molecules around the electrode bases do not respond or the response of the liquid crystal molecules is slow. Thus, in the case where an electrode base is disposed in an opening as in FIG. 19 of JP 2014-232136 A, the liquid crystal display device may have a low transmittance and a low response speed. Improvements can therefore still be made to increase the transmittance and response speed of the liquid crystal display device.

In response to the above issues, an object of the present invention is to provide a horizontal alignment mode liquid crystal display device that can achieve an increased response speed and an increased transmittance.

The present inventors made various studies on a horizontal alignment mode liquid crystal display device that can achieve an increased response speed and an increased transmittance, and focused on the shape of openings used to generate fringe electric fields. The inventors then found a structure in which an electrode is provided with a plurality of openings each having a long shape with two or more wide portions and one or more narrow portions. The two or more wide portions and the one or more narrow portions in each of the openings alternate with each other in the lengthwise direction of the opening. Adjacent two openings among the openings are formed such that a wide portion and a narrow portion of one of the openings are adjacent to a narrow portion and a wide portion of the other opening, respectively. This structure can reduce the distance between the adjacent two openings to reduce the space where liquid crystal molecules do not respond, further increasing the transmittance. The structure also can reduce liquid crystal molecules far from the electrode ends and slow to respond, further increasing the response speed. Thereby, the inventors achieved the above object, completing the present invention.

In other words, one aspect of the present invention may be a liquid crystal display device including: a first substrate; a second substrate facing the first substrate; and a liquid crystal layer being disposed between the first substrate and the second substrate and containing liquid crystal molecules, the first substrate including a first electrode, a second electrode closer to the liquid crystal layer than the first electrode is, and an insulating film between the first electrode and the second electrode, the liquid crystal molecules being aligned in a direction parallel to the first substrate with no voltage applied, the second electrode being provided with openings formed side by side, the openings each having a long shape with two or more wide portions and one or more narrow portions, the two or more wide portions and the one or more narrow portions in each of the openings alternating with each other in a lengthwise direction of the opening, each of the wide portions of one of adjacent two openings among the openings being adjacent to one of the narrow portions of the other of the adjacent two openings, each of the narrow portions of the one opening being adjacent to one of the wide portions of the other opening.

Each of the openings may be line-symmetrical about a straight line parallel to or perpendicular to an initial alignment azimuth of the liquid crystal molecules.

The liquid crystal molecules may have positive anisotropy of dielectric constant.

The two or more wide portions and the one or more narrow portions in each of the openings may alternate with each other at an initial alignment azimuth of the liquid crystal molecules.

The liquid crystal molecules may have negative anisotropy of dielectric constant.

The two or more wide portions and the one or more narrow portions in each of the openings may alternate with each other in a direction perpendicular to an initial alignment azimuth of the liquid crystal molecules.

The present invention can provide a horizontal alignment mode liquid crystal display device that can achieve an increased response speed and an increased transmittance.

### BRIEF DESCRIPTION OF THE DRAWINGS

FIG. 1A and FIG. 1B are views of a liquid crystal display device of Embodiment 1 with voltage applied; FIG. 1A is a schematic cross-sectional view of the liquid crystal display device utilizing liquid crystal molecules having positive anisotropy of dielectric constant, and FIG. 1B is a schematic cross-sectional view of the liquid crystal display device utilizing liquid crystal molecules having negative anisotropy of dielectric constant.

FIG. 2 is a view of a pixel circuit in the liquid crystal display device of Embodiment 1.

FIG. 3 is a schematic plan view of a counter electrode in the liquid crystal display device of Embodiment 1.

FIG. 4A and FIG. 4B are views of the liquid crystal display device of Embodiment 1; FIG. 4A is a schematic plan view illustrating the alignment of liquid crystal molecules with voltage applied, and FIG. 4B is a plan view illustrating an exemplary simulation result of the alignment distribution of the liquid crystal molecules with voltage applied.

FIG. 5A and FIG. 5B are views of a liquid crystal display device of Reference Example 1; FIG. 5A is a schematic plan view of a counter electrode, and FIG. 5B is a plan view illustrating a simulation result of the alignment distribution of liquid crystal molecules with voltage applied.

FIG. 6A and FIG. 6B are views of a liquid crystal display device of Comparative Example 1; FIG. 6A is a schematic plan view of a counter electrode, and FIG. 6B is a plan view illustrating a simulation result of the alignment distribution of liquid crystal molecules with voltage applied.

FIG. 7A, FIG. 7B, and FIG. 7C are views of liquid crystal display devices of Reference Examples 2-1 to 2-3;

FIG. 7A is a schematic plan view of a counter electrode in Reference Example 2-1, FIG. 7B is a schematic plan view of a counter electrode in Reference Example 2-2, and FIG. 7C is a schematic plan view of a counter electrode in Reference Example 2-3.

FIG. 8A and FIG. 8B are views of a liquid crystal display device of Example 1; FIG. 8A is a schematic plan view of a counter electrode, and FIG. 8B is a plan view illustrating a simulation result of the alignment distribution of liquid crystal molecules with voltage applied.

FIG. 9A and FIG. 9B are views of a liquid crystal display device of Reference Example 3; FIG. 9A is a schematic plan view of a counter electrode, and FIG. 9B is a plan view illustrating a simulation result of the alignment distribution of liquid crystal molecules with voltage applied.

FIG. 10A and FIG. 10B are views of a liquid crystal display device of Comparative Example 2-1; FIG. 10A is a schematic plan view of a counter electrode, and FIG. 10B is a plan view illustrating a simulation result of the alignment distribution of liquid crystal molecules with voltage applied.

FIG. 11A and FIG. 11B are views of a liquid crystal display device of Comparative Example 2-2; FIG. 11A is a schematic plan view of a counter electrode, and FIG. 11B is a plan view illustrating a simulation result of the alignment distribution of liquid crystal molecules with voltage applied.

FIG. 12 is a schematic plan view illustrating the alignment of liquid crystal molecules with no voltage applied in a liquid crystal display device of Reference Example 4.

FIG. 13A and FIG. 13B are views of the liquid crystal display device of Reference Example 4; FIG. 13A is a schematic plan view illustrating the alignment of the liquid crystal molecules with voltage applied, and FIG. 13B is a plan view illustrating a simulation result of the alignment distribution of the liquid crystal molecules with voltage applied.

FIG. 14A and FIG. 14B are views of the liquid crystal display device of Reference Example 4 and a liquid crystal display device of Comparative Example 3; FIG. 14A is a schematic plan view of a counter electrode in the liquid crystal display device of Comparative Example 3, and FIG. 14B is a schematic plan view of a counter electrode in the liquid crystal display device of Reference Example 4.

FIG. 15A and FIG. 15B are views of the liquid crystal display devices of Reference Example 4 and Comparative Example 3; FIG. 15A is a plan view illustrating a simulation result of the alignment distribution of liquid crystal molecules with voltage applied in the liquid crystal display device of Comparative Example 3, and FIG. 15B is a plan view illustrating a simulation result of the alignment distribution of the liquid crystal molecules with voltage applied in the liquid crystal display device of Reference Example 4.

FIG. 16A and FIG. 16B are views of a counter electrode in a liquid crystal display device; FIG. 16A is a schematic plan view of the counter electrode in the liquid crystal display device of Comparative Example 1, and FIG. 16B is a schematic plan view of the counter electrode in the liquid crystal display device of Reference Example 1.

FIG. 17A and FIG. 17B are views of a conventional FFS mode liquid crystal display device; FIG. 17A is a schematic plan view illustrating the alignment of liquid crystal molecules with no voltage applied, and FIG. 17B is a schematic plan view illustrating the alignment of the liquid crystal molecules with voltage applied.

FIG. 18A and FIG. 18B are views of the liquid crystal display device of Comparative Example 1; FIG. 18A is a schematic plan view illustrating the alignment of the liquid crystal molecules with no voltage applied, and FIG. 18B is a schematic plan view illustrating the alignment of the liquid crystal molecules with voltage applied.

FIG. 19 is a schematic plan view illustrating the alignment of liquid crystal molecules with voltage applied in a conventional FFS mode liquid crystal display device.

FIG. 20 is a schematic plan view illustrating liquid crystal correlation lengths using the conventional FFS mode liquid crystal display device.

FIG. 21 is a schematic plan view illustrating the alignment of the liquid crystal molecules with voltage applied in the liquid crystal display device of Comparative Example 1.

FIG. 22A and FIG. 22B are views of the liquid crystal display device of Comparative Example 1; FIG. 22A is a schematic plan view illustrating the alignment of liquid crystal molecules in the case where the left and right electrode ends are independent of each other, and FIG. 22B is a schematic plan view illustrating the alignment of the liquid crystal molecules with both the left and right electrode ends taken into consideration.

FIG. 23 is a view illustrating the relationship between the shape of a counter electrode and the response speed in a liquid crystal display device.

### DETAILED DESCRIPTION OF THE INVENTION

An embodiment of the present invention is described below. The embodiment, however, is not intended to limit the scope of the present invention. The embodiment may appropriately be modified within the spirit of the present invention.

The same portions or portions having similar functions hereinbelow are provided with similar reference signs in different figures, and those portions are not described repeatedly.

The configurations in the embodiment may appropriately be combined or modified within the spirit of the present invention.

### Embodiment 1

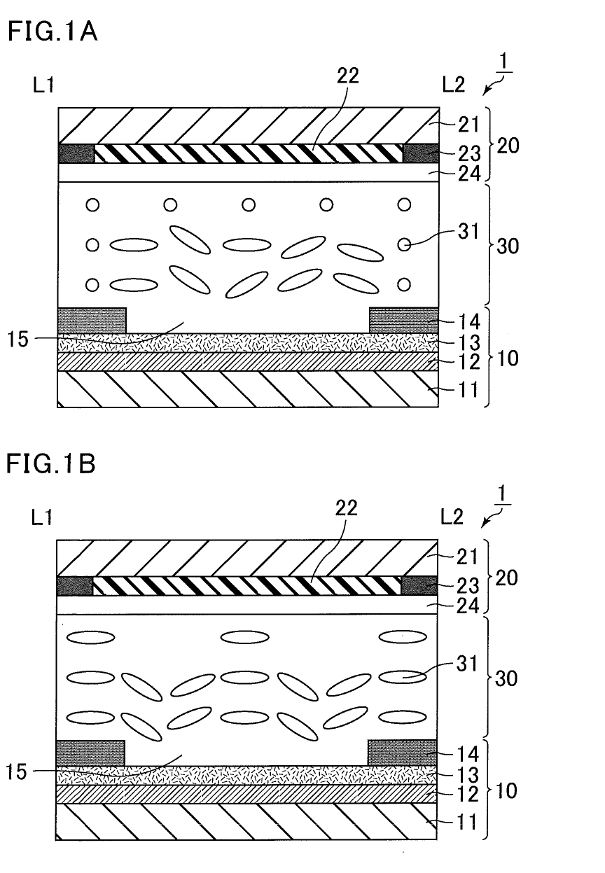

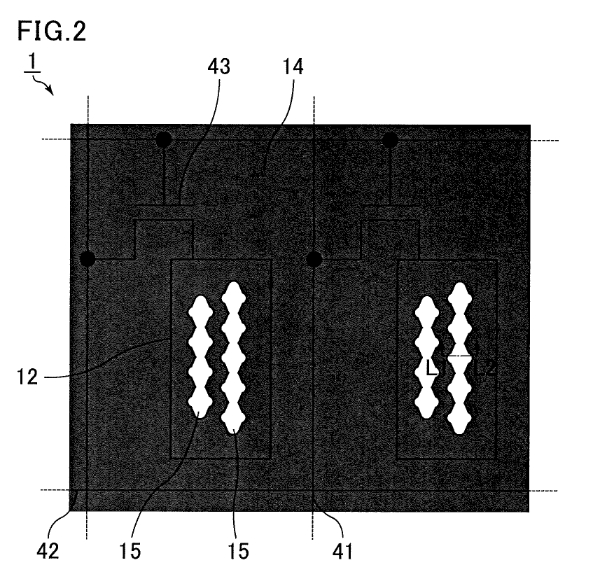

The present embodiment is described with an FFS mode liquid crystal display device taken as an example. FIG. 1A and FIG. 1B are views of a liquid crystal display device of Embodiment 1 with voltage applied; FIG. 1A is a schematic cross-sectional view of the liquid crystal display device utilizing liquid crystal molecules having positive anisotropy of dielectric constant, and FIG. 1B is a schematic cross-sectional view of the liquid crystal display device utilizing liquid crystal molecules having negative anisotropy of dielectric constant. FIG. 2 is a view of a pixel circuit in the liquid crystal display device of Embodiment 1. Both FIGS. 1A and 1B show a cross section taken along the line L1-L2 shown in FIG. 2. Liquid crystal molecules having positive anisotropy of dielectric constant are also referred to as positive liquid crystal molecules. Liquid crystal molecules having negative anisotropy of dielectric constant are also referred to as negative liquid crystal molecules.

As shown in FIG. 1A and FIG. 1B and FIG. 2, a liquid crystal display device 1 of the present embodiment includes a pair of substrates consisting of a first substrate 10 including thin-film transistors (TFTs) as switching elements and a second substrate 20 disposed to face the first substrate 10, and a liquid crystal layer 30 containing liquid crystal molecules 31 between the substrates. A plane parallel to the main surface of at least one of the first substrate 10 and the second substrate 20 as used herein is also simply referred to as a “plane”.

The first substrate 10 has a structure including a first polarizer (not shown), an insulating substrate 11, pixel electrodes (first electrodes) 12, an insulating film 13, and a counter electrode (second electrode) 14 sequentially stacked toward the liquid crystal layer 30. The first substrate 10 is also referred to as an active matrix substrate. A backlight (not shown) is disposed at the side remote from the liquid crystal layer 30 of the first substrate 10. These members may be disposed in the order of the first substrate 10, the liquid crystal layer 30, the second substrate 20, and the backlight.

The first substrate 10 includes data lines 41, scanning lines 42 crossing the data lines 41, and TFTs 43. Each of the TFTs 43 is connected to the corresponding data line 41 among the data lines 41 and the corresponding scanning line 42 among the scanning lines 42. The TFT 43 is a three-terminal switch containing a thin-film semiconductor, a source electrode composed of part of the corresponding data line 41, a gate electrode composed of part of the corresponding scanning line 42, and a drain electrode connected to the corresponding pixel electrode 12 among the pixel electrodes 12.

The second substrate 20 has a structure including a second polarizer (not shown), an insulating substrate 21, a color filter layer 22 and a black matrix layer 23, and an overcoat layer 24 sequentially stacked toward the liquid crystal layer 30. The second substrate 20 is also referred to as a color filter substrate. The overcoat layer 24 flattens the surface close to the liquid crystal layer 30 of the second substrate 20 and may be, for example, an organic film (dielectric constant ε=3 to 4).

The liquid crystal display device 1 of the present embodiment includes display units arranged in a matrix form. The pixel electrodes 12 in the first substrate 10 are planar electrodes disposed in the respective display units. The “display units” are each a region corresponding to one pixel electrode 12, and may be a “pixel” in the art of liquid crystal display devices. If one pixel is divisionally driven, the display unit may be a “sub-pixel”, “dot”, or “picture element”.

The counter electrode 14 supplies a common potential to the display units and is stacked on the pixel electrodes 12 with an insulating film 13 in between, covering substantially the entire surface (except for the openings for fringe electric field generation) of the first substrate 10. The insulating film 13 can be, for example, an organic film (dielectric constant ε=3 to 4), an inorganic film (dielectric constant ε=5 to 7) such as silicon nitride (SiNx) or silicone oxide (SiO₂), or a stack of these films. The counter electrode 14 may be electrically connected to an external connection terminal in a peripheral portion (frame region) of the first substrate 10. The counter electrode 14 is provided with openings 15 formed side by side in the row direction in which the scanning lines 42 extend.

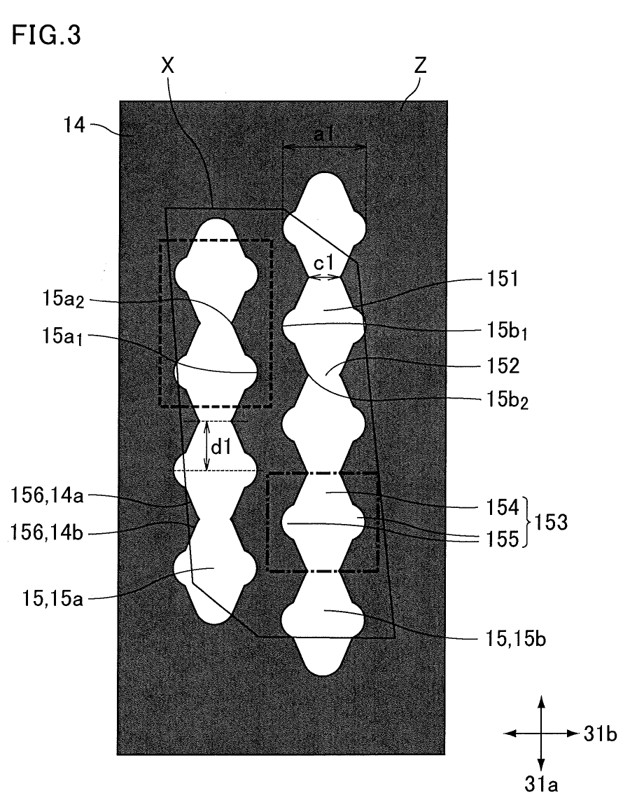

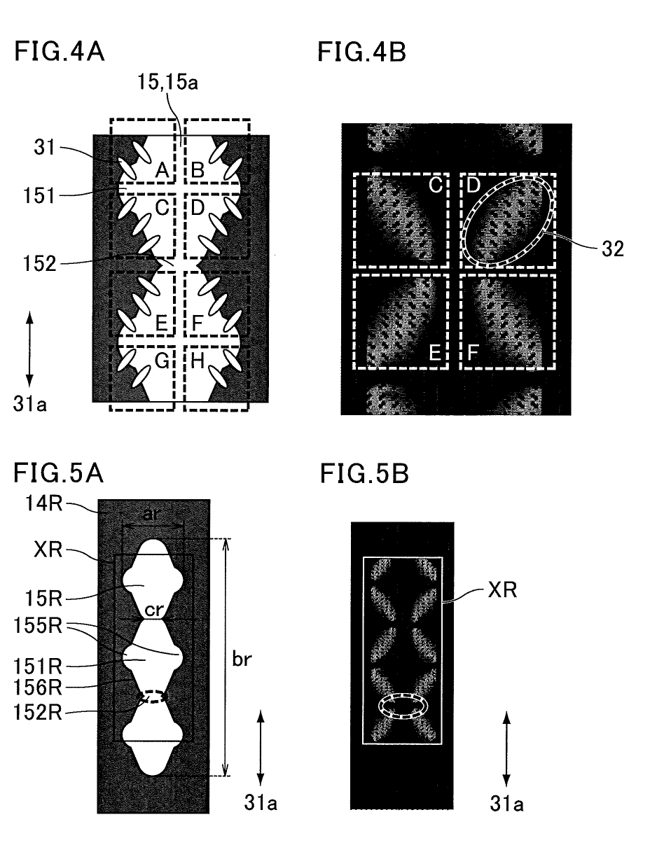

The openings 15 formed in the counter electrode 14 are described with reference to FIG. 3 and FIG. 4A and FIG. 4B. FIG. 3 is a schematic plan view of a counter electrode in the liquid crystal display device of Embodiment 1. FIG. 4A and FIG. 4B are views of the liquid crystal display device of Embodiment 1; FIG. 4A is a schematic plan view illustrating the alignment of liquid crystal molecules with voltage applied, and FIG. 4B is a plan view illustrating an exemplary simulation result of the alignment distribution of the liquid crystal molecules with voltage applied. FIG. 4A is a view illustrating a region surrounded by the dashed quadrangle in FIG. 3, while FIG. 4B is a view illustrating a region near the center of FIG. 4A. FIG. 4A and FIG. 4B are also views illustrating the liquid crystal molecules 31 having positive anisotropy of dielectric constant. The simulations mentioned herein are performed using LCD-Master 3D from Shintech, Inc. The state herein in which voltage is applied between any of the pixel electrodes (first electrodes) 12 and the counter electrode (second electrode) 14 is also simply referred to as “with voltage applied”. The state in which voltage is not applied between any of the pixel electrodes (first electrodes) 12 and the counter electrode (second electrode) 14 is also simply referred to as “with no voltage applied”. The alignment azimuth of the liquid crystal molecules 31 with no voltage applied is also referred to as the initial alignment azimuth of the liquid crystal molecules 31. The alignment azimuth of the liquid crystal molecules 31 is a direction of the major axes of the liquid crystal molecules 31 projected on a plane parallel to the main surface of the first substrate 10 or the second substrate 20.

In the present embodiment, the counter electrode 14 is provided with the openings 15 formed side by side. Each opening 15 has a long shape with two or more wide portions 151 and one or more narrow portions 152. The two or more wide portions 151 and the one or more narrow portions 152 in each opening 15 alternate with each other in the lengthwise direction of the opening 15. In this structure, with voltage applied, liquid crystal domains 32 are formed in respective regions A, B, C, D, E, F, G, and H which extend in the 45° directions from the center of a wide portion 151 or the center of a narrow portion 152. This enables the liquid crystal molecules 31 in adjacent liquid crystal domains 32 to rotate at opposite azimuths. The liquid crystal molecules are therefore aligned in a bend- and splay-shaped manner in a narrow region, and the distortion force generated by this alignment enables a rapid response in the horizontal alignment mode without complicating the shape of the counter electrode 14. Similar liquid crystal domains are formed also when utilizing the liquid crystal molecules 31 having negative anisotropy of dielectric constant, so that a rapid response is enabled. The case where the liquid crystal molecules 31 have negative anisotropy of dielectric constant is described in detail in the later-described Reference Example 4.

This structure also reduces the distance between adjacent electrode ends 14a and 14b formed at different angles in a plane, enabling an overlap between a region where the alignment of the liquid crystal molecules 31 is changed by the electrode end 14a and a region where the alignment of the liquid crystal molecules 31 is changed by the electrode end 14b. In other words, the range where the long-range interaction of the liquid crystal molecules 31 is effective when an electric field is generated at the electrode end 14a can overlap the range where the long-range interaction of the liquid crystal molecules 31 is effective when an electric field is generated at the electrode end 14b. In the overlap portion of ranges where the long-range interactions are effective, the alignment change of the liquid crystal molecules 31 by the long-range interactions are limited. Hence, when the ranges where the long-range interactions are effective overlap at a position far from the electrode ends, i.e., a position where the response of the liquid crystal molecules 31 is slow, the liquid crystal molecules 31 at the position far from the electrode ends do not, or substantially do not, respond. This seems to increase the response speed. The response speed is considered to be increased by the same mechanism also when the liquid crystal molecules 31 having negative anisotropy of dielectric constant are used.

In the present embodiment, each of the wide portions of one of adjacent two openings (hereinafter, the opening is also referred to as a first opening 15a) among the openings is adjacent to one of the narrow portions of the other of the adjacent two openings (hereinafter, the opening is also referred to as a second opening 15b), and each of the narrow portions of the first opening 15a is adjacent to one of the wide portions of the second opening 15b. This structure can reduce the distance between the adjacent two openings 15 to reduce the space where the liquid crystal molecules 31 do not respond, further increasing the transmittance. The structure also can reduce the liquid crystal molecules 31 far from the electrode ends and slow to respond, further increasing the response speed. The response speed and the transmittance are considered to be increased by the same mechanism also when the liquid crystal molecules 31 having negative anisotropy of dielectric constant are used.

The width (width in the widthwise direction) of each opening 15 repeats a monotonic decrease and a monotonic increase in the lengthwise direction of the opening 15. Each opening 15 alternately has the largest width in the lengthwise direction (hereinafter, also referred to as the maximum width) and the smallest width in the lengthwise direction (hereinafter, also referred to as the minimum width). A wide portion 151 and a narrow portion 152 adjacent to each other are in contact with each other at a boundary line where the opening 15 has the average width obtained by dividing the sum of the maximum width of the wide portion 151 and the minimum width of the narrow portion 152 by two. The boundary line defines the boundary between the wide portion 151 and the narrow portion 152. The maximum width corresponds to the later-described maximum width a1 of each wide portion 151, and the minimum width corresponds to the later-described minimum width c1 of each narrow portion 152.

In each opening 15, the two or more wide portions 151 preferably have substantially the same width as each other, but at least one of the wide portions 151 may have a different width. The wide portions 151 of each opening 15 preferably have substantially the same width as the wide portions 151 of the other openings 15, but may have a different width.

In the case where each opening 15 includes two or more narrow portions 152, the narrow portions 152 in each opening 15 preferably have substantially the same width as each other, but at least one of the narrow portions 152 may have a different width. The narrow portions 152 of each opening 15 preferably have substantially the same width as the narrow portions 152 of the other openings 15, but may have a different width.

In each opening 15, each wide portion 151 preferably has a maximum width a1 of 5 μm or greater and 10 μm or smaller, more preferably 5.5 μm or greater and 9.5 μm or smaller. Each narrow portion 152 preferably has a minimum width c1 of 1 μm or greater and 4 μm or smaller, more preferably 1.5 μm or greater and 3.5 μm or smaller. Each wide portion 151 preferably has a maximum width a1 that is double or more and sextuple or less, more preferably triple or more and quintuple or less, the minimum width c1 of the narrow portion 152 adjacent to the wide portion 151.

In each opening 15, a distance d1 in the lengthwise direction between a maximum width a1 portion of a wide portion 151 and a minimum width c1 portion of an adjacent narrow portion 152 is preferably 2.5 μm or greater and 28.5 μm or smaller, more preferably 3 μm or greater and 28 μm or smaller. With a distance d1 of 2.5 μm or greater and 28.5 μm or smaller, setting the initial alignment azimuth of the positive liquid crystal molecules 31 in the direction parallel to a straight line parallel to the lengthwise direction of the opening 15 enables inclination of an opening end 156 from the initial alignment azimuth of the liquid crystal molecules 31 by 5° or greater and 45° or smaller. In the case of using the positive liquid crystal molecules 31, setting the angle formed by each opening end 156 and the initial alignment azimuth of the liquid crystal molecules 31 to 45° enables the response speed to be the highest. Decreasing the angle enables the transmittance to increase, although decreasing the response speed. Also with a distance d1 of 2.5 μm or greater and 28.5 μm or smaller, setting the initial alignment azimuth of the negative liquid crystal molecules 31 in the direction parallel to a straight line parallel to the widthwise direction of the opening 15 enables inclination of the opening end 156 from the initial alignment azimuth of the liquid crystal molecules 31 by 45° or greater and 85° or smaller. In the case of using the negative liquid crystal molecules 31, setting the angle formed by the opening end 156 and the initial alignment azimuth of the liquid crystal molecules 31 to 45° enables the response speed to be the highest. Increasing the angle enables the transmittance to increase, although decreasing the response speed.

Each opening 15 is preferably line-symmetric about a straight line parallel to the lengthwise direction of the opening 15 or a straight line parallel to the widthwise direction of the opening 15, more preferably about a straight line parallel to the lengthwise direction of the opening 15 and a straight line parallel to the widthwise direction of the opening 15. This structure can increase the symmetry of the liquid crystal domains 32 formed with voltage applied, further increasing the response speed. Each opening 15 being line-symmetric about a straight line parallel to the lengthwise direction of the opening 15 or a straight line parallel to the widthwise direction of the opening 15 includes cases where each opening 15 is perfectly line-symmetric or substantially line-symmetric about a straight line parallel to the lengthwise direction of the opening 15 or a straight line parallel to the widthwise direction of the opening 15.

Each opening 15 preferably has a shape formed by repetitive opening units 153 having a predetermined shape. The opening units 153 are each a portion corresponding to the region surrounded by a dot-dashed line in FIG. 3. Each opening unit 153 preferably includes a main portion 154 and a pair of protruding portions 155 protruding in opposite directions from the center in the lengthwise direction of the main portion 154 of the opening 15. With this structure, oblique electric fields can form stable liquid crystal domains 32, further increasing the response speed.

Each opening 15 has a shape in which shapes each including the pair of protruding portions 155 protruding in the opposite directions from the center portion in the lengthwise direction of the shape overlap each other at at least one of their upper end and lower end. The shape is an ellipse or an ellipse-like shape such as an oval having two axes of symmetry. The protruding portions 155 protrude in the opposite directions (outward, widthwise direction) from the main portion 154 and are formed at the opposite ends of the main portion 154 in the lengthwise direction of the opening 15. Each protruding portion 155 may have any size and may protrude from the main portion 154 significantly or slightly. Each protruding portion 155 has only to protrude from the main portion 154, and the outline thereof may be arc- or elliptical arc-shaped, curved, or irregular. Each protruding portion 155 may also have a polygonal shape such as a triangular or trapezoidal (the longer base is adjacent to the main portion 154) shape, or a shape obtained by rounding at least one of the corners of such a polygon.

Each opening 15 preferably has the opening end 156 inclined from the initial alignment azimuth of the liquid crystal molecules 31. Such an opening end 156 inclined from the initial alignment azimuth of the liquid crystal molecules 31 is also simply referred to as an “inclined portion” hereinbelow, and the inclined portion does not include the protruding portions 155. This structure enables smooth rotation of the liquid crystal molecules 31 with voltage applied, further increasing the response speed. In the case where the liquid crystal molecules 31 have positive anisotropy of dielectric constant are used, the angle formed by the initial alignment azimuth of the liquid crystal molecules 31 and the inclined portion is, in a plan view, preferably 5° or greater and 45° or smaller, more preferably 10° or greater and 40° or smaller. In the case where the liquid crystal molecules 31 have negative anisotropy of dielectric constant are used, the angle formed by the initial alignment azimuth of the liquid crystal molecules 31 and the inclined portion is, in a plan view, preferably 45° or greater and 85° or smaller, more preferably 50° or greater and 80° or smaller. In the case where the angle formed by the initial alignment azimuth of the liquid crystal molecules 31 and the inclined portion is 45°, the liquid crystal molecules 31 can rotate smoothly and thus the response speed can be the highest. As the angle formed by the initial alignment azimuth of the positive liquid crystal molecules 31 and the inclined portion becomes closer to 0°, or as the angle formed by the initial alignment azimuth of the negative liquid crystal molecules 31 and the inclined portion becomes closer to 90°, the transmittance can be further increased. Hence, setting the angle formed by the initial alignment azimuth of the liquid crystal molecules 31 and the inclined portion to 5° or greater and 45° or smaller or to 45° or greater and 85° or smaller enables a further increased response speed and a further increased transmittance.

In each opening 15, the number of the wide portions 151 and the number of the narrow portions 152 are not particularly limited, and may each appropriately be set according to the pixel size and the opening size of the black matrix layer 23. For example, each opening 15 preferably includes two or more and seven or less wide portions 151 and one or more and six or less narrow portions 152, more preferably three or more and six or less wide portions 151 and two or more and five or less narrow portions 152.

In FIG. 3, the inside of a region X surrounded by a hexagon is a light transmissive region, i.e., a region without a black matrix layer, and the outside of the region X is a light blocking region Z, i.e., a region with a black matrix layer. At least one end (preferably both ends) in the lengthwise direction of each opening 15 is preferably within the light blocking region Z. The response of the liquid crystal molecules 31 outside each opening 15 is slow. Hence, the above structure can further increase the response speed in the display region.

In the present embodiment, the other opening 15 (second opening 15b) side opening end 15al of a wide portion 151 and the second opening 15b side opening end 15a2 of a narrow portion 152 in one of adjacent two openings 15 (first opening 15a) among the openings 15 are respectively alongside a first opening 15a side opening end 15b2 of a narrow portion 152 and a first opening 15a side opening end 15b1 of a wide portion 151 in the other of the adjacent two openings 15 (second opening 15b). Also, a wide portion 151 and a narrow portion 152 of the first opening 15a and a narrow portion 152 and a wide portion 151 of the adjacent second opening 15b are adjacent to each other, respectively.

The shortest distance between the first opening 15a and the second opening 15b adjacent to each other may differ at different positions, but is preferably within a range that is less than a double of the liquid crystal correlation length. This structure can reduce a portion with a small overlap of the liquid crystal correlation lengths between the first opening 15a and the second opening 15b, further increasing the response speed. The liquid crystal correlation length can be adjusted using, for example, a physical property value such as anisotropy of dielectric constant or elastic constant of the liquid crystal material, or the degree of restriction (anchoring energy) of an alignment film. For example, the liquid crystal correlation length can be increased by increasing the anisotropy of dielectric constant of the liquid crystal material, increasing the elastic constant of the liquid crystal material, or lowering the degree of restriction of the alignment film.

The liquid crystal correlation length can be determined as follows, for example. When voltage is applied between a pixel electrode 12 and the counter electrode 14, an electric field is generated at the electrode ends, so that the liquid crystal molecules 31 are re-aligned. In the region between the electrode ends, the liquid crystal molecules 31 are affected by multiple electrode ends and thereby re-aligned. In determination of the liquid crystal correlation length, however, a region where the alignment of the liquid crystal molecules 31 changes is determined by simulation, assuming that each electrode end is present alone. The distance from the electrode end to an end of the region where the alignment of the liquid crystal molecules 31 changes is measured, so that the liquid crystal correlation length can be determined.

At least two openings 15 are preferably formed in each display unit. The upper limit of the number of the openings 15 in one display unit is not particularly limited, but is preferably five or less, more preferably three or less. For an increase in the transmittance, the number of the openings 15 is preferably as small as possible.

Each opening 15 is preferably line-symmetric about a straight line parallel or perpendicular to the initial alignment azimuth of the liquid crystal molecules 31. This structure can increase the symmetry of the liquid crystal domains 32 formed with voltage applied, further increasing the response speed. Each opening 15 being line-symmetric about a straight line parallel or perpendicular to the initial alignment azimuth of the liquid crystal molecules 31 includes cases where each opening 15 is perfectly line-symmetric or substantially line-symmetric about a straight line parallel or perpendicular to the initial alignment azimuth of the liquid crystal molecules 31.

In the case where the liquid crystal layer 30 contains a liquid crystal material having positive anisotropy of dielectric constant and the liquid crystal molecules 31 have positive anisotropy of dielectric constant, the two or more wide portions 151 and the one or more narrow portions 152 of each opening 15 preferably alternate with each other at the initial alignment azimuth of the liquid crystal molecules 31. This structure can fix crossing dark lines as shown in FIG. 4B in the wide portion 151 (especially in the protruding portions 155 in the wide portion 151) and give a high effectively applicable design voltage, further increasing the transmittance. In this case, the lengthwise direction of each opening 15 may be parallel to the initial alignment azimuth of the liquid crystal molecules 31.

In the case where the liquid crystal layer 30 contains a liquid crystal material having negative anisotropy of dielectric constant and the liquid crystal molecules 31 have negative anisotropy of dielectric constant, the two or more wide portions 151 and the one or more narrow portions 152 of each opening 15 preferably alternate with each other in the direction perpendicular to the initial alignment azimuth of the liquid crystal molecules 31. This structure can fix crossing dark lines as shown in FIG. 4B in the wide portion 151 (especially in the protruding portions 155 in the wide portion 151) and give a high effectively applicable design voltage, further increasing the transmittance. In this case, the widthwise direction (direction perpendicular to the lengthwise direction) of each opening 15 may be parallel to the initial alignment azimuth of the liquid crystal molecules 31.

In the present embodiment, the alignment of the liquid crystal molecules 31 with voltage applied is controlled by the laminate of the pixel electrodes 12, the insulating film 13, and the counter electrode 14 formed on the first substrate 10. In other words, the liquid crystal display device 1 of the present embodiment can control the alignment of the liquid crystal molecules 31 in the liquid crystal layer 30 by varying the voltage applied between the pixel electrodes 12 and the counter electrode 14. In the present embodiment, the counter electrode 14 provided with the openings 15 is disposed on the planar pixel electrodes 12. The positions of the pixel electrodes 12 and the counter electrode 14 may be switched to form pixel electrodes on a planar counter electrode and form the openings 15 in the pixel electrodes. Also, “with voltage applied” means a state where at least the minimum voltage (threshold voltage) required to rotate the liquid crystal molecules 31 under the influence of electric fields and change the alignment azimuth is applied, and may be a state where voltage for white display (white voltage) is applied.

Although not shown in FIG. 1A and FIG. 1B, an alignment film is usually disposed on the liquid crystal layer 30 side surface of the first substrate 10 and/or the second substrate 20. The alignment film controls the alignment of the liquid crystal molecules 31 with no voltage applied. The alignment film may be an organic or inorganic film.

In the present embodiment, a horizontal alignment film is used, which aligns the liquid crystal molecules 31 with no voltage applied in the direction parallel to the first substrate 10 and the second substrate 20. The horizontal alignment film aligns the nearby liquid crystal molecules 31 in the direction parallel to the surface of the alignment film. Also, the horizontal alignment film can align the major axes of the liquid crystal molecules 31 aligned in the direction parallel to the first substrate 10 to a specific direction. A suitable horizontal alignment film is, for example, one on which an alignment treatment such as photo-alignment or rubbing has been performed. For example, in the case where the display units are quadrangular and the liquid crystal molecules 31 having positive anisotropy of dielectric constant are used, the photo-alignment or the rubbing can be performed on the alignment film in the lengthwise direction of the display units. In the case where the display units are quadrangular and the liquid crystal molecules 31 having negative anisotropy of dielectric constant are used, the photo-alignment or the rubbing can be performed on the alignment film in the widthwise direction of the display units. The horizontal alignment film may be a film formed of an inorganic material or a film formed of an organic material.

The “parallel” alignment of the liquid crystal molecules 31 includes the perfect parallel state and states equated with the parallel state (substantially parallel state) in the art. The pre-tilt angle (inclination angle with no voltage applied) of the liquid crystal molecules 31 is preferably smaller than 30, more preferably smaller than 1°, particularly preferably 0° using a photo-alignment film, from the surface of the first substrate 10. Setting the pre-tilt angle to 0° eliminates the influence of the pre-tilt angle on the liquid crystal domains, enabling the four liquid crystal domains to be uniformly kept in a balanced state.

The liquid crystal molecules 31 may have negative or positive anisotropy of dielectric constant (Δε), which is calculated from the following formula. In other words, the liquid crystal molecules 31 may have negative anisotropy of dielectric constant or positive anisotropy of dielectric constant.

Δε=(dielectric constant in major axis direction)−(dielectric constant in minor axis direction)

A liquid crystal material containing the liquid crystal molecules 31 having negative anisotropy of dielectric constant tends to have a relatively high viscosity. Thus, for a high response speed, a liquid crystal material containing the liquid crystal molecules 31 having positive anisotropy of dielectric constant is advantageous. However, even with a liquid crystal material having negative anisotropy of dielectric constant, the same effects can be achieved in the same manner as in the present embodiment as long as the viscosity of the liquid crystal material is as low as that of the liquid crystal material having positive anisotropy of dielectric constant. The initial alignment azimuth of the liquid crystal molecules 31 having negative anisotropy of dielectric constant is in the direction rotated by 90 degrees from the liquid crystal molecules 31 having positive anisotropy of dielectric constant. Also, the liquid crystal molecules 31 having positive anisotropy of dielectric constant with voltage applied are aligned such that the major axes thereof are perpendicular to the outline (opening end 156) of each opening 15, whereas the liquid crystal molecules 31 having negative anisotropy of dielectric constant with voltage applied are aligned such that the major axes thereof are parallel to the outline of each opening 15.

The definition of the liquid crystal display device 1 is not particular limited, but is preferably 300 ppi or higher and 1000 ppi or lower, more preferably 350 ppi or higher and 800 ppi or lower. The definition (pixel per inch: ppi) as used herein means the number of pixels per inch (2.54 cm). In the case of dividing one pixel into sub-pixels (display units) and divisionally driving the pixels, the definition may be calculated using the size of one pixel consisting of multiple sub-pixels.

The first polarizer and the second polarizer are each an absorptive polarizer, and are in crossed Nicols where the absorptive axes thereof are perpendicular to each other. One of the polarization axis of the first polarizer and the polarization axis of the second polarizer is in the direction parallel to the initial alignment azimuth of the liquid crystal molecules 31, and the other of them is in the direction perpendicular to the initial alignment azimuth of the liquid crystal molecules 31.

The liquid crystal display device 1 may include, as well as the above members, members such as optical films, including a retardation film, a viewing angle-increasing film, and a luminance-increasing film; external circuits, including a tape-carrier package (TCP) and a printed circuit board (PCB); and a bezel (frame). These members are not particularly limited, and may be those usually used in the field of liquid crystal display devices. The description of these components is thus omitted.

An embodiment of the present invention has been described above. Each and every detail described for the above embodiment is applicable to all the aspects of the present invention.

The present invention is described in more detail below based on an example, comparative examples, and reference examples. The example, however, is not intended to limit the scope of the present invention.

### Reference Example 1 and Comparative Example 1

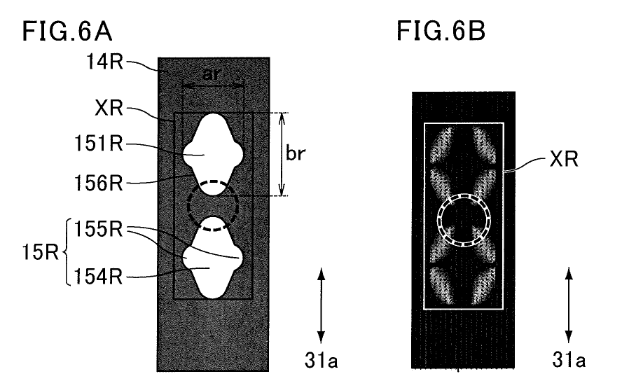

Liquid crystal display devices of Reference Example 1 and Comparative Example 1 have the same configuration as the liquid crystal display device of Embodiment 1 described above, except that the openings in the counter electrode have a different shape. FIG. 5A and FIG. 5B are views of the liquid crystal display device of Reference Example 1; FIG. 5A is a schematic plan view of a counter electrode, and FIG. 5B is a plan view illustrating a simulation result of the alignment distribution of liquid crystal molecules with voltage applied. FIG. 6A and FIG. 6B are views of the liquid crystal display device of Comparative Example 1; FIG. 6A is a schematic plan view of a counter electrode, and FIG. 6B is a plan view illustrating a simulation result of the alignment distribution of liquid crystal molecules with voltage applied.

Openings 15R having the shape as shown in FIG. 5A were formed in the counter electrode 14R of the liquid crystal display device of Reference Example 1. The openings 15R in the counter electrode 14R of the liquid crystal display device of Reference Example 1 each had wide portions 151R and narrow portions 152R alternating with each other at an initial alignment azimuth 31a of the liquid crystal molecules. Each wide portion 151R included a pair of protruding portions 155R such that the upper and lower liquid crystal domains are symmetrically defined. In Reference Example 1, one opening 15R in the counter electrode 14R was formed per display unit. Each wide portion 151R in FIG. 5A had a maximum width ar of 8.5 μm, each opening 15R had a length br in the lengthwise direction of 35.9 μm, and each narrow portion 152R had a minimum width cr of 2.6 μm. The angle formed by an opening end 156R inclined from the initial alignment azimuth 31a of the liquid crystal molecules and the initial alignment azimuth 31a of the liquid crystal molecules was set to 25°. The inside of a region XR surrounded by a quadrangle in FIG. 5A and FIG. 5B is a light transmissive region, i.e., a region without a black matrix layer, and the outside of the region XR is a light blocking region, i.e., a region with the black matrix layer.

The liquid crystal layer had a refractive index anisotropy (Δn) of 0.11, an in-plane retardation (Re) of 310 nm, and a viscosity of 70 cps. The liquid crystal molecules had an anisotropy of dielectric constant (Δε) of 7 (positive). The initial alignment azimuth of the liquid crystal molecules was set to be parallel to the lengthwise direction of the display units. Also, a pair of polarizing plates was disposed such that one polarizing plate was on the side remote from the liquid crystal layer of one of the substrates holding the liquid crystal layer in between, and the other polarizing plate was on the side remote from the liquid crystal layer of the other substrate. The polarizing plates were disposed in crossed Nicols, with the absorptive axis of one of the polarizing plates being parallel and the absorptive axis of the other being perpendicular, to the initial alignment azimuth of the liquid crystal molecules. The liquid crystal display device was therefore in the normally black mode where it provides black display with no voltage applied to the liquid crystal layer.

The liquid crystal display device of Comparative Example 1 has the same configuration as the liquid crystal display device of Reference Example 1, except that each opening 15R in the counter electrode 14R had the shape shown in FIG. 6A. Each opening 15R in Comparative Example 1 includes a main portion 154R and the pair of protruding portions 155R protruding in the opposite directions from the main portion 154R. Each wide portion 151R in FIG. 6A had a maximum width ar of 8.5 μm, and each opening 15R had a length br in the lengthwise direction of 12.5 m. Also, the angle formed by each opening end 156R inclined from the initial alignment azimuth 31a of the liquid crystal molecules and the initial alignment azimuth 31a of the liquid crystal molecules was set to 25°. The inside of the region XR surrounded by a quadrangle in FIG. 6A and FIG. 6B is a light transmissive region, i.e., a region without a black matrix layer, and the outside of the region XR is a light blocking region, i.e., a region with the black matrix layer.

The transmittance of each of the liquid crystal display devices of Reference Example 1 and Comparative Example 1 with a voltage of 4.5 V applied was simulated. The results are shown in the following Table 1. The transmittance of the liquid crystal display device of Reference Example 1 was determined with the transmittance of the liquid crystal display device of Comparative Example 1 taken as 100%. The sizes of the black matrix layer and the pixel electrodes in Reference Example 1 and Comparative Example 1 in the simulations were set to be the same as each other.

TABLE 1

| | Comparative | Reference |
|---|---|---|
| | Example 1 | Example 1 |
| Transmittance | 100% | 108% |

The results of Table 1 show that the transmittance of the liquid crystal display device of Reference Example 1 was higher than the transmittance of the liquid crystal display device of Comparative Example 1 by 8%. The liquid crystal display device of Comparative Example 1 caused a region between the openings 15R (region surrounded by a dashed circle in FIG. 6A and FIG. 6B) to appear as dark lines and hardly increased the transmittance. Also, since the distance from each electrode end to the liquid crystal molecules is large between the openings 15R, the response speed seems to be low. In contrast, in Reference Example 1, the openings 15R formed in the counter electrode 14R each include the wide portions 151R and the narrow portions 152R alternating with each other. The dark lines were therefore thinner than those in Comparative Example 1 as shown in the region surrounded by the dotted circle in FIG. 5A and FIG. 5B, so that the transmittance seems to have been increased. As shown in the region surrounded by the dotted circle in FIG. 5A and FIG. 5B, the distance from each electrode end to the liquid crystal molecules can be reduced in Reference Example 1 as compared with Comparative Example 1, and thus the response speed of the liquid crystal display device of Reference Example 1 seems to be further increased as compared with Comparative Example 1.

### Reference Examples 2-1 to 2-3

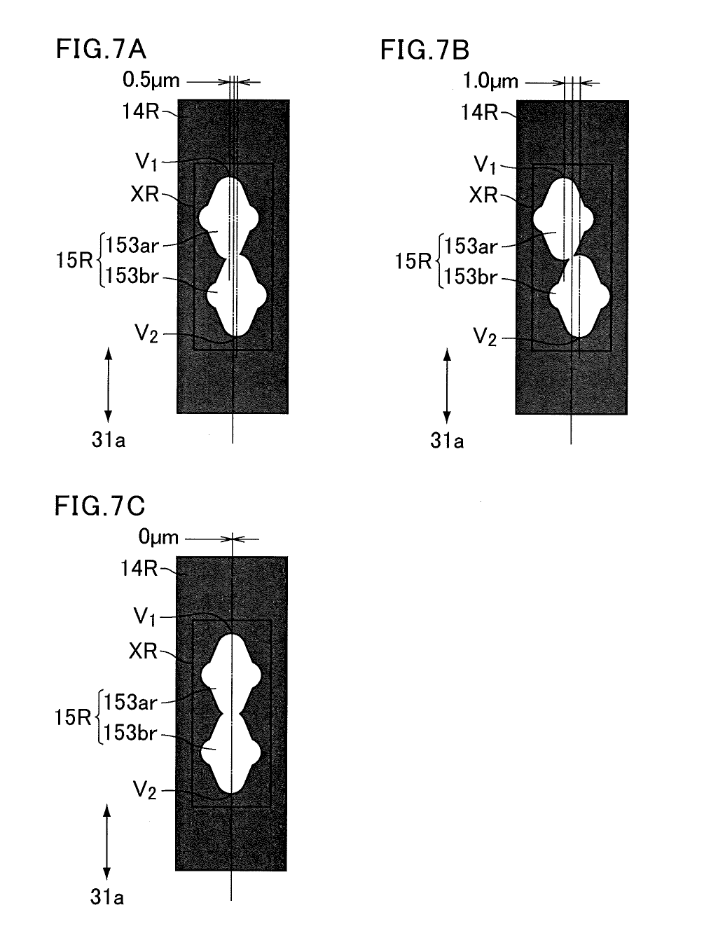

Liquid crystal display devices of Reference Examples 2-1 to 2-3 have the same configuration as the liquid crystal display device of Reference Example 1 described above, except that the openings in the counter electrode have a different shape. FIG. 7A, FIG. 7B, and FIG. 7C are views of liquid crystal display devices of Reference Examples 2-1 to 2-3; FIG. 7A is a schematic plan view of a counter electrode in Reference Example 2-1, FIG. 7B is a schematic plan view of a counter electrode in Reference Example 2-2, and FIG. 7C is a schematic plan view of a counter electrode in Reference Example 2-3.

In an opening including wide portions and narrow portions alternately, it is important that a line segment connecting the upper and lower vertexes in the lengthwise direction of the opening is parallel to the initial alignment azimuth of liquid crystal molecules and that the opening has a shape that is line-symmetrical about the initial alignment azimuth of liquid crystal molecules. As shown in FIG. 7C, in the liquid crystal display device of Reference Example 2-3, a straight line passing an upper vertex V₁ in the lengthwise direction of the opening 15R and being parallel to the initial alignment azimuth 31a of the liquid crystal molecules and a straight line passing a lower vertex V₂ in the lengthwise direction of the opening 15R and being parallel to the initial alignment azimuth 31a of the liquid crystal molecules are shifted by 0 μm. This shows that the opening 15R in Reference Example 2-3 is line-symmetrical about the initial alignment azimuth 31a of liquid crystal molecules.

The case where the opening is asymmetrical about the initial alignment azimuth of liquid crystal molecules is described based on Reference Examples 2-1 and 2-2. As shown in FIGS. 7A and 7B, the liquid crystal display devices of Reference Examples 2-1 and 2-2 have the same configuration as a liquid crystal display device of Reference Example 2-3, except that the straight line passing the upper vertex V₁ in the lengthwise direction of the opening 15R and being parallel to the initial alignment azimuth 31a of the liquid crystal molecules and the straight line passing the lower vertex V₂ in the lengthwise direction of the opening 15R and being parallel to the initial alignment azimuth 31a of the liquid crystal molecules were shifted by 0.5 μm and 1.0 μm in the liquid crystal display devices of Reference Examples 2-1 and 2-2, respectively. In other words, in the opening 15R in Reference Example 2-1, opening units 153ar and 153br constituting the opening 15R in Reference Example 2-3 were shifted leftward and rightward by 0.25 μm, respectively, from the line segment connecting the upper vertex V₁ and the lower vertex V₂ in the opening 15R in Reference Example 2-3. Also, in the opening 15R in Reference Example 2-2, opening units 153ar and 153br constituting the opening 15R in Reference Example 2-3 were shifted leftward and rightward by 0.5 μm, respectively, from the line segment connecting the upper vertex V₁ and the lower vertex V₂ in the opening 15R in Reference Example 2-3. The opening 15R in Reference Example 2-3 was line-symmetrical about a straight line parallel to the long sides of the pixel electrodes.

The response times of the liquid crystal display devices of Reference Examples 2-1 to 2-3 when voltage was changed from 0 V to 4.5 V were determined by simulation. The response time is the time required for the transmittance to change from 10% to 90% (the maximum transmittance with a voltage of 0 V applied is taken as 0% and the maximum transmittance with a voltage of 4.5 V applied is taken as 100%). The results are shown in Table 2. The response times of the liquid crystal display devices of Reference Examples 2-1 and 2-2 were determined with the response time of the liquid crystal display device of Reference Example 2-3 taken as 100%.

TABLE 2

| | Reference | Reference | Reference |
|---|---|---|---|
| | Example 2-1 | Example 2-2 | Example 2-3 |
| Response time | 104% | 114% | 100% |

The results in Table 2 show that the response speed of the liquid crystal display device of Reference Example 2-3 was higher than that of the liquid crystal display devices of Reference Examples 2-1 and 2-2. The results therefore suggest that, for an increase in the response speed, the opening 15R is preferably line-symmetrical about a straight line parallel to the initial alignment azimuth 31a of the liquid crystal molecules.

### Example 1, Reference Example 3, and Comparative Examples 2-1 and 2-2

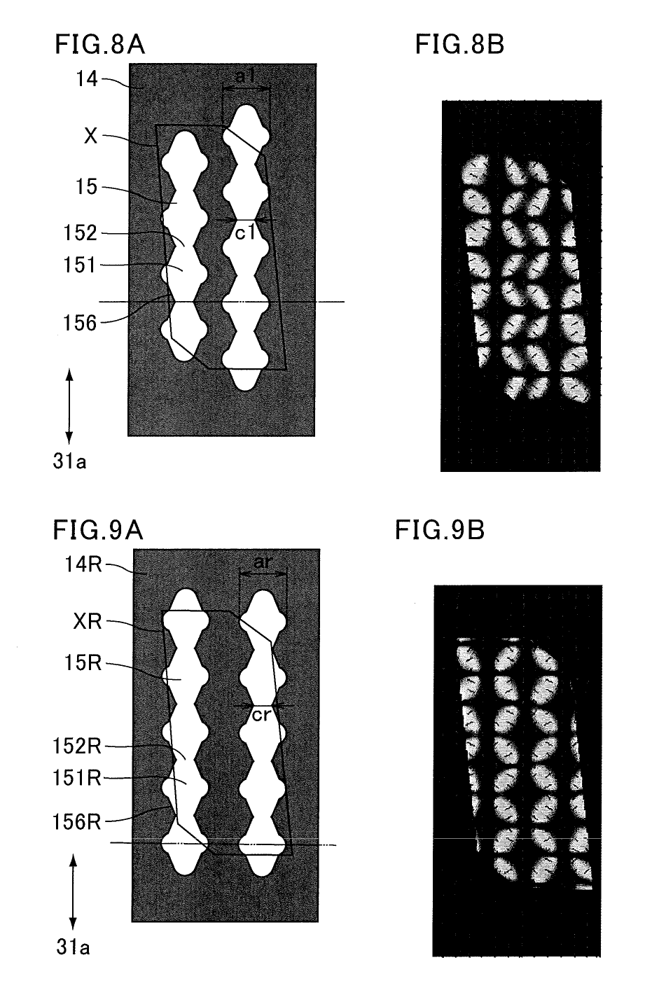

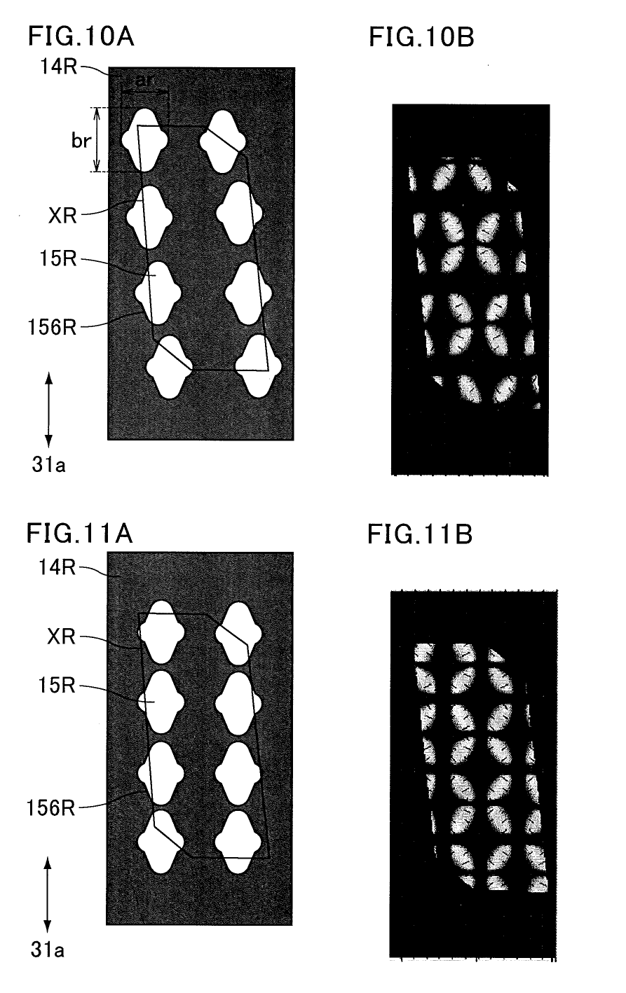

FIG. 8A and FIG. 8B are views of a liquid crystal display device of Example 1; FIG. 8A is a schematic plan view of a counter electrode, and FIG. 8B is a plan view illustrating a simulation result of the alignment distribution of liquid crystal molecules with voltage applied. FIG. 9A and FIG. 9B are views of a liquid crystal display device of Reference Example 3; FIG. 9A is a schematic plan view of a counter electrode, and FIG. 9B is a plan view illustrating a simulation result of the alignment distribution of liquid crystal molecules with voltage applied. FIG. 10A and FIG. 10B are views of a liquid crystal display device of Comparative Example 2-1; FIG. 10A is a schematic plan view of a counter electrode, and FIG. 10B is a plan view illustrating a simulation result of the alignment distribution of liquid crystal molecules with voltage applied. FIG. 11A and FIG. 11B are views of a liquid crystal display device of Comparative Example 2-2; FIG. 11A is a schematic plan view of a counter electrode, and FIG. 11B is a plan view illustrating a simulation result of the alignment distribution of liquid crystal molecules with voltage applied. In Example 1, Reference Example 3, and Comparative Examples 2-1 and 2-2, the initial alignment azimuth of liquid crystal molecules was set in the lengthwise direction of the display units.

The openings 15 having the shape as shown in FIG. 8A and FIG. 8B were formed in the counter electrode 14 in the liquid crystal display device of Example 1. In other words, in Example 1, two lines of the openings 15 each including the wide portions 151 and the narrow portions 152 alternately were formed in each display unit. The center of each wide portion 151 of one of the adjacent openings 15 and the center of a narrow portion 152 of the other of the adjacent openings 15 were on a straight line perpendicular to the initial alignment azimuth of liquid crystal molecules and a straight line perpendicular to the long sides of the pixel electrode 12. In Example 1, each of the wide portions 151 of one of the adjacent two openings 15 was adjacent to one of the narrow portions 152 of the other of the adjacent two openings 15, and each of the narrow portions 152 of the one opening 15 was adjacent to one of the wide portions 151 of the other opening 15. Each opening 15 has a shape in which elliptical shapes each including protruding portions, which are the center portion in the major axis direction of the elliptical shape protruding to form arcs, overlap each other at at least one of their upper end and lower end. Each opening 15 also has a shape in which elliptical shapes each including the pair of protruding portions 155 protruding in the opposite directions from the center portion in the lengthwise direction of the elliptical shape overlap each other at at least one of their upper end and lower end.

In Example 1, each wide portion 151 had a maximum width a1 of approximately 7.3 m, each narrow portion 152 had a minimum width c1 of approximately 1.8 m, and the angle formed by each opening end 156 inclined from the initial alignment azimuth of liquid crystal molecules and the initial alignment azimuth 31a of liquid crystal molecules was set to 25°.

The openings 15R having the shape as shown in FIG. 9A and FIG. 9B were formed in the counter electrode in the liquid crystal display device of Reference Example 3. In other words, in Reference Example 3, two lines of the openings 15 each including the wide portions 151R and the narrow portions 152R alternately were formed in each display unit. The center of each wide portion 151R of one of the adjacent openings 15 and the center of a wide portion 151R of the other of the adjacent openings 15 were on a straight line perpendicular to the initial alignment azimuth of liquid crystal molecules and a straight line perpendicular to the long sides of a pixel electrode 12R. In Reference Example 3, each wide portion 151R of one of the adjacent two openings 15 was adjacent to one of the wide portions 151R of the other of the adjacent two openings 15R, and each of the narrow portions 152R of the one opening 15 was adjacent to one of the narrow portions 152R of the other opening 15.

In Reference Example 3, each wide portion 151 had a maximum width ar of approximately 7.5 m, each narrow portion 152R had a minimum width cr of approximately 1.8 m, and the angle formed by each opening end 156R inclined from the initial alignment azimuth of the liquid crystal molecules and the initial alignment azimuth 31a of the liquid crystal molecules was set to 25°.

The openings 15R having the shape as shown in FIG. 10A and FIG. 10B were formed in the counter electrode 14R in the liquid crystal display device of Comparative Example 2-1. In other words, in Comparative Example 2-1, eight openings 15R similar to those in Comparative Example 1 were formed separately in each display unit. The openings 15R having the shape as shown in FIG. 11A and FIG. 11B were formed in the counter electrode 14R in the liquid crystal display device of Comparative Example 2-2. In other words, in Comparative Example 2-2, eight openings 15R were formed at a narrower interval than in Comparative Example 2-1.

In Comparative Example 2-1 and Comparative Example 2-2, each wide portion had a maximum width ar of approximately 7.5 m, and each opening 15R had a length br in the lengthwise direction of approximately 10.9 m. The angle formed by each opening end 156R inclined from the initial alignment azimuth of the liquid crystal molecules and the initial alignment azimuth of the liquid crystal molecules was set to 25°.

The transmittances of the liquid crystal display devices of Example 1, Reference Example 3, and Comparative Examples 2-1 and 2-2 were determined by simulation. Also, the liquid crystal display devices of the example, reference examples, and comparative examples herein take the longest time to respond in a change from display at a grayscale value of 0 to display at a grayscale value of about 128 as in a common FFS mode liquid crystal display device. Thus, the response time required to change display at a grayscale value of 0 to display at a grayscale value of 128 (gray to gray worst response time: the time required for the transmittance to change from 10% to 90% in transmittance change, where the transmittance of display at a grayscale value of 0 is taken as 0% and the maximum transmittance of display at a grayscale value of 128 is taken as 100%) was measured using an actual device capable of providing display at 256 grayscale vales. This response time is the longest among all the response times in grayscale changes including intermediate grayscale changes. The transmittances of the liquid crystal display devices of Comparative Example 2-2, Reference Example 3, and Example 1 were determined with the transmittance of the liquid crystal display device of Comparative Example 2-1 taken as 100%. The response times of the liquid crystal display devices of Comparative Example 2-2, Reference Example 3, and Example 1 were determined with the response time of the liquid crystal display device of Comparative Example 2-1 taken as 100%.

TABLE 3

| | Comparative | Comparative | Reference | |
|---|---|---|---|---|
| | Example 2-1 | Example 2-2 | Example 3 | Example 1 |
| Transmittance | 100% | 116% | 119% | 135% |
| Response time | 100% | 84% | 79% | 76% |

The above results show that the response speed is increased by decreasing or eliminating the interval between adjacent openings 15 or between adjacent openings 15R. The reasons thereof are presumably as follows. When voltage is applied between electrodes, the response of the liquid crystal molecules starts from the protruding portions formed in the widthwise direction of each of the openings 15 and 15R, and thus the response of the liquid crystal molecules at the upper vertex and the lower vertex of each of the openings 15 and 15R is relatively slow. Also, the alignment forced by the fringe electric field spreads to the outside of the openings 15 and 15R, but the alignments of the liquid crystal molecules outside the openings 15 and 15R do not collide or less collide with each other. These liquid crystal molecules therefore respond by their own viscoelasticity. The response of such liquid crystal molecules is slow. This is presumably why in Comparative Example 2-2 in which the interval between the openings 15R was smaller than that in Comparative Example 2-1, the dark lines were thinner, the transmittance was higher, and the response speed was higher by 16%.

In Reference Example 3, the formation ratio of the openings 15R was higher than those in Comparative Example 2-1 and Comparative Example 2-2. Hence, the transmittance was 119% of that in Comparative Example 2-1, and the regions where the response of the liquid crystal molecules was slow between the openings 15R were eliminated. This is presumably why the response time shortened to 79%.

In Example 1, the formation ratio of the openings 15 was higher than that in Reference Example 3, and the alignment in the regions where the response of the liquid crystal molecules was slow outside the openings 15 was controlled by the electric fields. This is presumably why the transmittance was 135% of that in Comparative Example 2-1, the response time shortened to 76%, and a high transmittance and a high response speed were achieved.

### Reference Example 4 and Comparative Example 3

A liquid crystal display device of Reference Example 4 has the same configuration as the liquid crystal display device of Reference Example 1, except that liquid crystal molecules having negative anisotropy of dielectric constant were used and the initial alignment azimuth of the liquid crystal molecules was set to be parallel to the widthwise direction of the display units. In Reference Example 4, the angle formed by each opening end inclined from an initial alignment azimuth 31b of liquid crystal molecules and the initial alignment azimuth 31b of the liquid crystal molecules was set to 65°. Also in the liquid crystal display device of Reference Example 4, the liquid crystal molecules 31R in the liquid crystal layer had an anisotropy of dielectric constant (Δε) of −7 (negative).

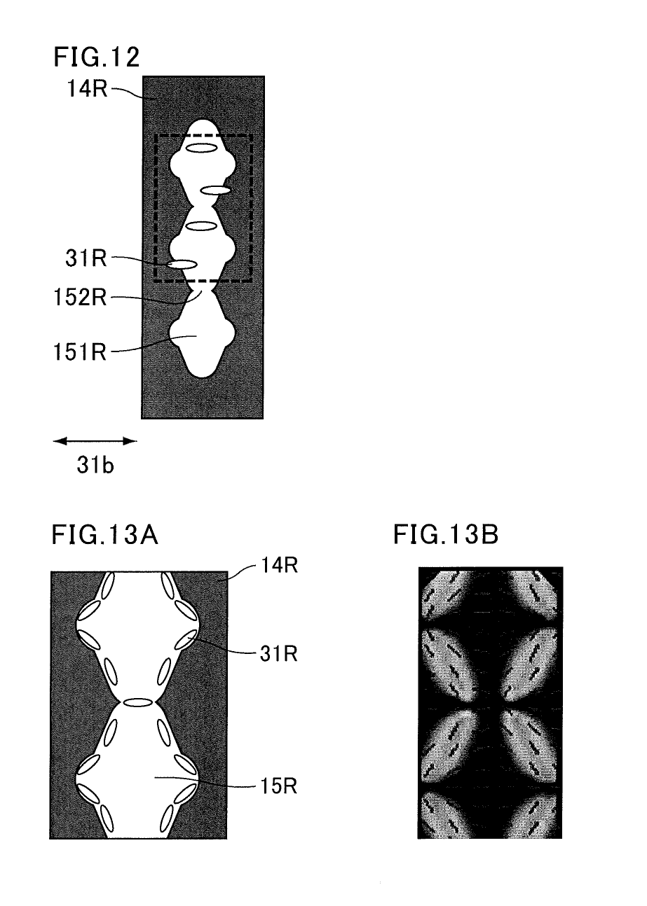

FIG. 12 is a schematic plan view illustrating the alignment of liquid crystal molecules with no voltage applied in the liquid crystal display device of Reference Example 4. FIG. 13A and FIG. 13B are views of the liquid crystal display device of Reference Example 4; FIG. 13A is a schematic plan view illustrating the alignment of the liquid crystal molecules with voltage applied, and FIG. 13B is a plan view illustrating a simulation result of the alignment distribution of the liquid crystal molecules with voltage applied. FIG. 13A and FIG. 13B are views illustrating the region surrounded by the dashed square in FIG. 12.

In Reference Example 4 in which liquid crystal molecules having negative anisotropy of dielectric constant were used, as shown in FIG. 12, the initial alignment azimuth 31b of liquid crystal molecules was parallel to the widthwise direction of the display units. The liquid crystal molecules 31R having negative anisotropy of dielectric constant with voltage applied were aligned with the major axes of the liquid crystal molecules 31R being along the outline of the opening 15R as shown in FIG. 13A.

The alignment distribution of the liquid crystal molecules 31R with voltage applied (4.5 V application) in the liquid crystal display device of Reference Example 4 is described based on FIG. 13B. The liquid crystal molecules having negative anisotropy of dielectric constant in Reference Example 4 are in four liquid crystal domains formed in the respective 45-degree directions from each of the center of each wide portion 151R and the center of each narrow portion 152R as with the liquid crystal molecules having positive anisotropy of dielectric constant in Reference Example 1. This configuration sufficiently rotates the liquid crystal molecules 31R aligned in the 45-degree directions from each of the centers at the initial voltage application. Thus, a high response speed can be achieved as in the liquid crystal display device of Reference Example 1. In other words, even in the case of using liquid crystal molecules having negative anisotropy of dielectric constant, the same effects as those achieved by liquid crystal molecules having positive anisotropy of dielectric constant can be achieved.

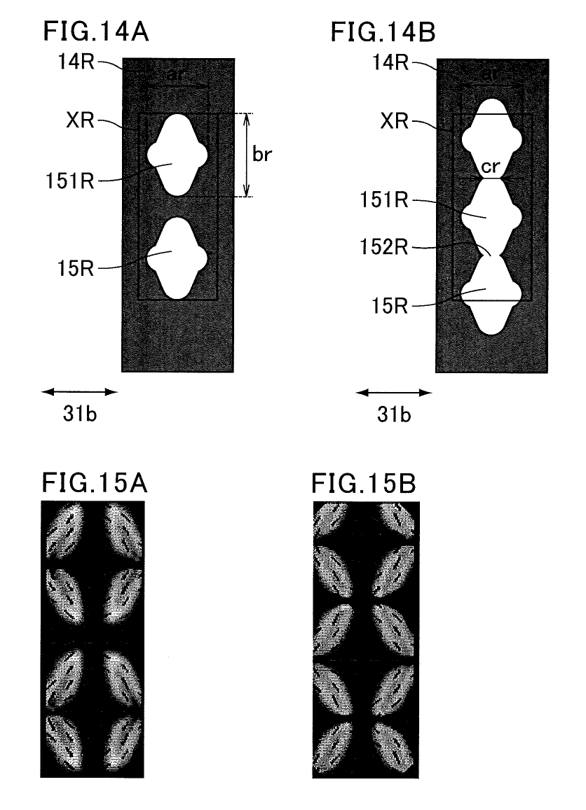

FIG. 14A and FIG. 14B are views of the liquid crystal display device of Reference Example 4 and a liquid crystal display device of Comparative Example 3; FIG. 14A is a schematic plan view of a counter electrode in the liquid crystal display device of Comparative Example 3, and FIG. 14B is a schematic plan view of a counter electrode in the liquid crystal display device of Reference Example 4. FIG. 15A and FIG. 15B are views of the liquid crystal display devices of Reference Example 4 and Comparative Example 3; FIG. 15A is a plan view illustrating a simulation result of the alignment distribution of liquid crystal molecules with voltage applied in the liquid crystal display device of Comparative Example 3, and FIG. 15B is a plan view illustrating a simulation result of the alignment distribution of the liquid crystal molecules with voltage applied in the liquid crystal display device of Reference Example 4. The liquid crystal display device of Comparative Example 3 has the same configuration as that of Reference Example 4, except that the shape of the openings was changed to that in Comparative Example 1. The maximum width ar of each wide portion 151R of each opening and the length br in the lengthwise direction of each opening 15R in Comparative Example 4 were the same as those in Comparative Example 1. The maximum width ar of each wide portion 151R and the minimum width cr of each narrow portion 152R in each opening 15R in Reference Example 4 were the same as those in Reference Example 1.

The transmittances of the liquid crystal display devices of Reference Example 4 and Comparative Example 3 with a voltage of 4.5 V applied were simulated. The results are shown in the following Table 4. The transmittance of the liquid crystal display device of Reference Example 4 was determined with the transmittance of the liquid crystal display device of Comparative Example 3 taken as 100%.

TABLE 4

| | Comparative | Reference |
|---|---|---|
| | Example 3 | Example 4 |
| Transmittance | 100% | 106% |

The results in Table 4 show that the transmittance of the liquid crystal display device of Reference Example 4 was higher than that of the liquid crystal display device of Comparative Example 3 by 6%. The portions not being taken into account for the transmittance between the openings 15R are reduced in Reference Example 4 as compared with Comparative Example 3, which presumably led to a high transmittance.

The relationship between the liquid crystal correlation length and the response speed of liquid crystal molecules is further described below.

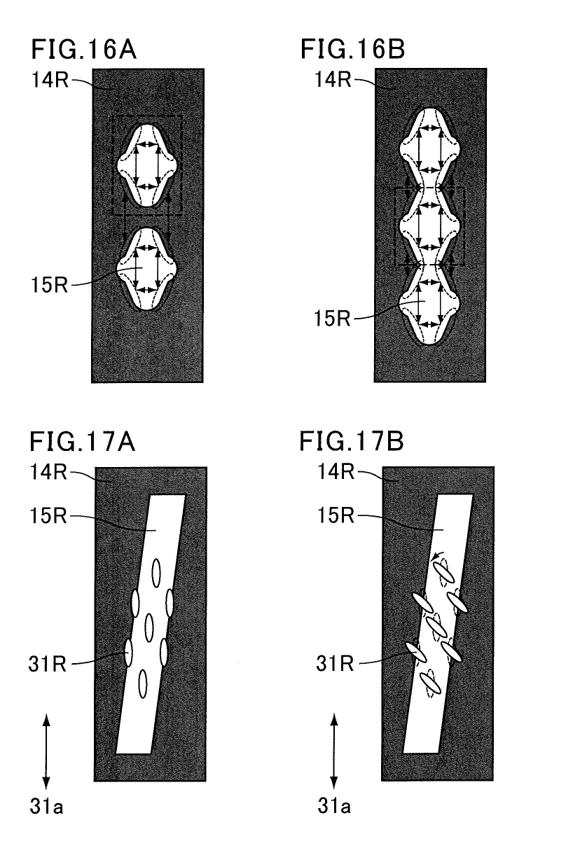

FIG. 16A and FIG. 16B are views of a counter electrode in a liquid crystal display device; FIG. 16A is a schematic plan view of the counter electrode in the liquid crystal display device of Comparative Example 1, and FIG. 16B is a schematic plan view of the counter electrode in the liquid crystal display device of Reference Example 1. The regions each surrounded by a dashed square in FIG. 16A and FIG. 16B are opening units. FIG. 16A and FIG. 16B show that “the distance (length indicated by a solid arrow) between electrode ends facing each other at different angles in a plane” in an opening unit is the same in Reference Example 1 and Comparative Example 1, but “the distance (length indicated by a dashed arrow) between electrode ends facing each other at different angles in a plane” between adjacent opening units is shorter in Reference Example 1 than in Comparative Example 1. This difference between “the distances (lengths indicated by dashed arrows) between electrode ends facing each other at different angles in a plane” between opening units is presumed to be a cause of the high response speed of the liquid crystal display device of Reference Example 1. The reasons therefor are as follows.

Before comparison between the liquid crystal display devices of Reference Example 1 and Comparative Example 1, a conventional FFS mode liquid crystal display device is described. FIG. 17A and FIG. 17B are views of a conventional FFS mode liquid crystal display device; FIG. 17A is a schematic plan view illustrating the alignment of liquid crystal molecules with no voltage applied, and FIG. 17B is a schematic plan view illustrating the alignment of the liquid crystal molecules with voltage applied. In the conventional FFS mode liquid crystal display device, the openings 15R shown in FIG. 17A and FIG. 17B are formed in the counter electrode 14R, and a fringe field generated between parallel electrode ends facing each other is used as the driving force to change the alignment of the liquid crystal molecules 31R. FIG. 17B shows that, with voltage applied, the fringe fields generated at the electrode ends in the same direction rotate all the liquid crystal molecules 31R in the plane in the same direction.

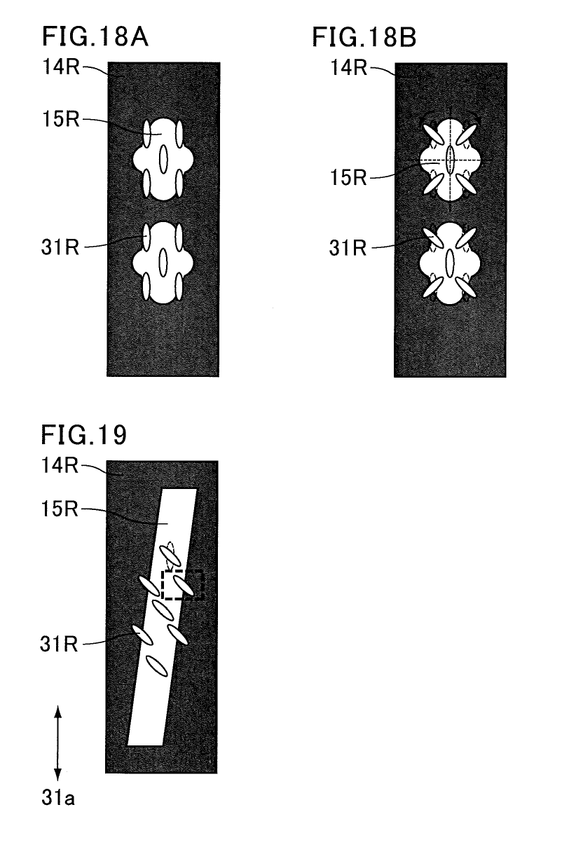

Comparative Example 1 is described. FIG. 18A and FIG. 18B are views of the liquid crystal display device of Comparative Example 1; FIG. 18A is a schematic plan view illustrating the alignment of the liquid crystal molecules with no voltage applied, and FIG. 18B is a schematic plan view illustrating the alignment of the liquid crystal molecules with voltage applied. In Comparative Example 1, a fringe field generated at “electrode ends facing each other at different angles in a plane” re-aligns the liquid crystal molecules 31R near the electrode ends by rotating them in the opposite directions between adjacent domains. At the boundary between the adjacent domains, the liquid crystal molecules 31R do not rotate in the plane due to the torque balance (long-range interaction of liquid crystal molecules). In other words, at the dashed cross portion in FIG. 18B, re-alignment of the liquid crystal molecules 31R by the electric field does not occur and thus dark lines (virtual walls) are observed. The virtual walls caused by the long-range interaction balance are important in understanding the mechanism of increasing the response speed.

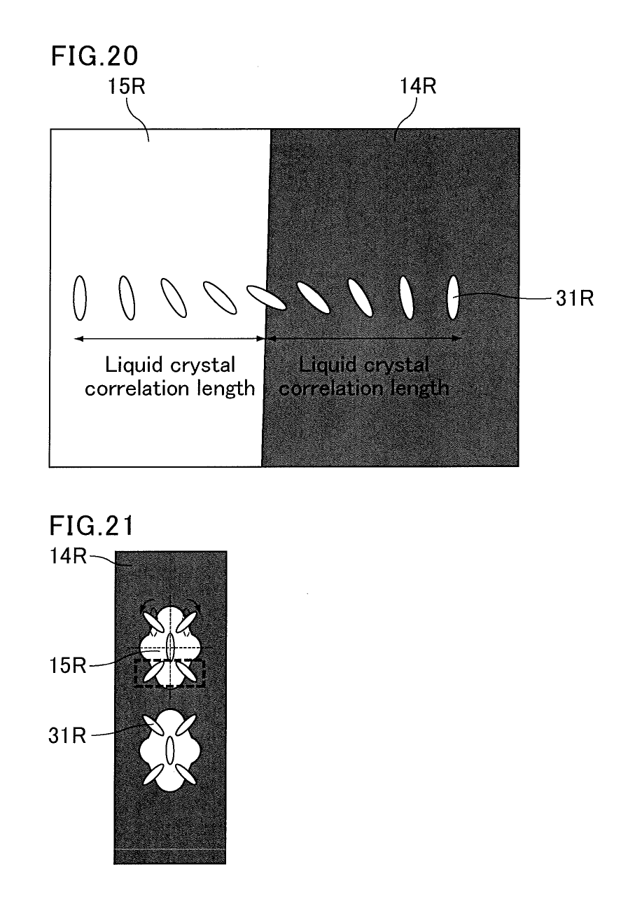

The liquid crystal long-range interaction is described. FIG. 19 is a schematic plan view illustrating the alignment of liquid crystal molecules with voltage applied in a conventional FFS mode liquid crystal display device. FIG. 20 is a schematic plan view illustrating liquid crystal correlation lengths using the conventional FFS mode liquid crystal display device. FIG. 20 is an enlarged view of the region surrounded by the dotted square in FIG. 19.

In the FFS mode liquid crystal display device, fringe fields generated at the electrode ends re-align liquid crystal molecules. Dielectric torque (also simply referred to as torque) applied to the liquid crystal molecules by the electric fields is at the maximum near the electrode ends, and the deformation amount (amount of in-plane rotation) of the liquid crystal molecules is also at the maximum in the plane. As the alignment of liquid crystal molecules changes at the electrode ends, the alignment of liquid crystal molecules therearound also changes to conform to the changed alignment. This interaction is also referred to as the long-range interaction of liquid crystal molecules. The distance in which the long-range interaction is effective is referred to as the liquid crystal correlation length.

As described above, in the FFS mode liquid crystal display device, the alignment change of the liquid crystal molecules 31R near the electrode ends spreads therearound, causing in-plane alignment change. This re-alignment dynamics of the liquid crystal molecules 31R shows a viscoelastic behavior, and thus the timing of the alignment change of the liquid crystal molecules 31R comes later at a position farther from the electrode ends. In other words, the alignment change of the liquid crystal molecules 31R near the electrode ends causes alignment change of the liquid crystal molecules 31R far from the electrode ends. Hence, the liquid crystal molecules 31R farther from the electrode ends start to respond at a later time point and also stop responding at a later time point.

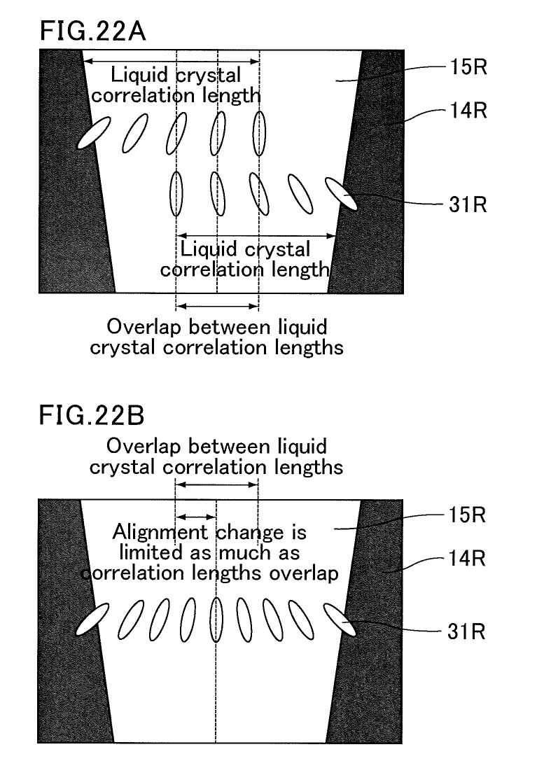

The reason why the response speed increases when the counter electrode has the electrode ends facing each other at different angles in a plane is described with Comparative Example 1 taken as an example. FIG. 21 is a schematic plan view illustrating the alignment of the liquid crystal molecules with voltage applied in the liquid crystal display device of Comparative Example 1. FIG. 22A and FIG. 22B are views of the liquid crystal display device of Comparative Example 1; FIG. 22A is a schematic plan view illustrating the alignment of liquid crystal molecules in the case where the left and right electrode ends are independent of each other, and FIG. 22B is a schematic plan view illustrating the alignment of the liquid crystal molecules with both the left and right electrode ends taken into consideration. In other words, FIG. 22A is an image showing the liquid crystal correlation length of each of the left and right electrodes alone. FIG. 22B shows the alignment of liquid crystal molecules when the liquid crystal correlation length is limited due to an alignment change of liquid crystal molecules at the left electrode end and an alignment change of liquid crystal molecules at a right electrode end. FIGS. 22A and 22B are each an enlarged view of the region surrounded by the dotted square in FIG. 21.

As the distance between the electrode ends is reduced to a distance where the liquid crystal correlation lengths overlap as shown in FIG. 22A, the alignment change by the long-range interaction is limited at a position that is far from the electrode ends and where the response speed is low as shown in FIG. 22B. This causes the liquid crystal molecules far from the electrode ends to be irrelevant to the response property, meaning that the response speed is increased. The positions where the alignment change by the long-range interaction is limited are not taken into account for the transmittance either.

With the openings 15R in Comparative Example 1 as shown in FIG. 22A and FIG. 22B, the response speed increasing effect can be achieved in the inside of the opening units. However, as to the outside of the opening units, the distance between the opening units is large, and thus the response speed increasing effect seems to be difficult to achieve.

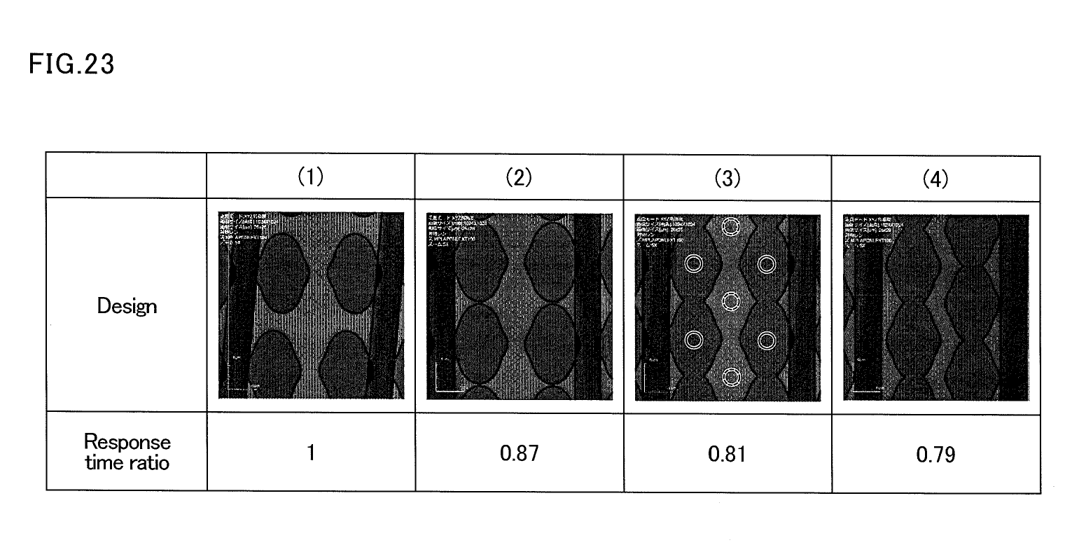

FIG. 23 is a view illustrating the relationship between the shape of a counter electrode and the response speed in a liquid crystal display device. The response time ratios shown in FIG. 23 are the measured results. The response time is the above-mentioned response time (gray to gray worst response time) from display at a grayscale value of 0 to display at a grayscale value of 128, and the response time ratios are each a ratio relative to the response time of the configuration in Comparative Example 1 as shown in the design (1) in FIG. 23. As described above, in the FFS mode, liquid crystal molecules farther from the electrode ends are relatively slower to respond in a plane. In the case where each opening has the shape as shown in the design (1) in FIG. 23, which is the configuration in Comparative Example 1, virtual walls appear only in the opening units in the counter electrode, and the effect is small in the outside of the opening units. When the distance between the upper and lower openings in the design (1) is reduced to that in the design (2), the response speed can be increased.

The response speed can be higher than that in the design (2) when the openings in the design (2) are connected to each other to form the shape shown in the design (3). In addition, the response speed can be higher than that in the design (3) when each narrow portion of the left opening of the openings formed in two lines and one of the wide portions of the right opening are formed side by side in the widthwise direction of the openings so that the openings have the shape as shown in the design (4), i.e., the shape in the above embodiment. This is because the response of the liquid crystal molecules is slow in the regions (positions near the intersections of the crossed dark lines and those far from the electrode ends) surrounded by the solid or dashed circles in the design (3). Forming openings as shown in the design (4) enables reduction of the regions surrounded by the dashed circles in the design (3), i.e., reduction of the portions where the overlap between the liquid crystal correlation lengths is small. This is presumably why the response speed in the design (4) is higher than that in the design (3).

What is claimed is:

1. A liquid crystal display device comprising:
a first substrate;
a second substrate facing the first substrate; and
a liquid crystal layer being disposed between the first substrate and the second substrate and containing liquid crystal molecules,
the first substrate including a first electrode, a second electrode closer to the liquid crystal layer than the first electrode is, and an insulating film between the first electrode and the second electrode,
the liquid crystal molecules being aligned in a direction parallel to the first substrate with no voltage applied,
the second electrode being provided with openings formed side by side,
the openings each having a long shape with two or more wide portions and one or more narrow portions,
the two or more wide portions and the one or more narrow portions in each of the openings alternating with each other in a lengthwise direction of the opening,
each of the wide portions of one of adjacent two openings among the openings being adjacent to one of the narrow portions of the other of the adjacent two openings,
each of the narrow portions of the one opening being adjacent to one of the wide portions of the other opening.

2. The liquid crystal display device according to claim 1,
wherein each of the openings is line-symmetrical about a straight line parallel to or perpendicular to an initial alignment azimuth of the liquid crystal molecules.

3. The liquid crystal display device according to claim 1,
wherein the liquid crystal molecules have positive anisotropy of dielectric constant.

4. The liquid crystal display device according to claim 3,
wherein the two or more wide portions and the one or more narrow portions in each of the openings alternate with each other at an initial alignment azimuth of the liquid crystal molecules.

5. The liquid crystal display device according to claim 1,
wherein the liquid crystal molecules have negative anisotropy of dielectric constant.

6. The liquid crystal display device according to claim 5,
wherein the two or more wide portions and the one or more narrow portions in each of the openings alternate with each other in a direction perpendicular to an initial alignment azimuth of the liquid crystal molecules.
